(19) United States
(12) Patent Application Publication
(10) Pub. No.: US 2016/0131343 A1
(43) Pub. Date: May 12, 2016

(54) Flashlight Holster and Headband

(71) Applicant: Richard Dulasky, Syracuse, NY (US)

(72) Inventor: Richard Dulasky, Syracuse, NY (US)

(21) Appl. No.: 14/538,324

(22) Filed: Nov. 11, 2014

(51) Int. Cl. F21V 21/084; F21V 33/00

(52) U.S. Cl. CPC F21V 21/084; F21V 33/0008

(57) ABSTRACT

A flashlight holster assembly is provided that generally includes a belt mount that includes a belt loop and a first fastener that are attached to one another, a holster having first and second surfaces and including a pocket formed in the first surface that is adapted to hold the flashlight therein, a second fastener attached to the holster and adapted for removable interconnection to the first fastener, thereby providing a means for connecting and disconnecting the holster from the belt mount, and a headband integrated with the holster, whereby upon disconnection of the holster from the belt mount, the headband may be donned by a user with the flashlight contained within the pocket and extending from the headband.

### REFERENCE TO RELATED APPLICATION

N/A

### BACKGROUND

1. Field of Invention

The present invention relates generally to holsters and more particularly to belt mounted holsters that can be converted into a headband.

2. Background of Art

Flashlights are used by, among other tradesman, automotive technicians who have a frequent need to shine the light on a part that is under the hood of the car or perhaps under the body of the car where shadows require illumination in order for the part to be adequately viewed. Most typically, the automotive technician will simply hold the flashlight in his or her hand while observing the part. When, however, the automotive technician must also use his or her hands to work on the part, the flashlight is either suspended from a hook or held between the technician's teeth. Such lighting arrangements are less than ideal insofar as stability of the light source and adjustability of the light a source are concerned.

3. Objects and Advantages

It is therefore an object and advantage of the present invention to provide a holster for containing a flashlight that can be converted into a headband such that the flashlight can be worn on the user's head.

It is another object and advantage of the present invention to provide a holster that is quickly and easily convertible into a headband.

Other objects and advantages of the present invention will in part be obvious and in part appear hereinafter.

### SUMMARY OF THE INVENTION

In accordance with the foregoing objects and advantages, the present invention provides a flashlight holster assembly, comprising a belt mount that includes a belt loop and a first fastener that are attached to one another; a holster having first and second surfaces and comprising a pocket formed in the first surface and adapted to hold the flashlight therein; a second fastener attached to the holster and adapted for removable interconnection to the first fastener, thereby providing a means for connecting and disconnecting the holster from the belt mount; and a headband integrated with the holster, whereby upon disconnection of the holster from the belt mount, the headband may be donned by a user with the flashlight contained within the pocket and extending from the headband.

More particularly, an embodiment of the flashlight holster assembly comprises a belt mount comprising a belt loop and a first fastener, a holster comprising a second fastener that is adapted for engagement with the first fastener, thereby removably interconnecting the holster to the belt mount, an elongated main body having an outwardly facing surface in which a pocket is formed and a rearward facing surface to which a sleeve is attached, and a headband secured to the rear facing surface. In assembling the device, the elongated edges of the sleeve formed in the rear surface of the holster's main body is stitched around a length of the headband, thereby securing the headband to the holster. The headband is also affixed around a transverse member that forms part of the second fastener, further securing the positioning of the headband to the holster.

Another aspect of the invention provides a method for converting a flashlight holster assembly between a belt mounted flashlight holster and a head mounted flashlight holster, wherein the flashlight holster assembly comprises a belt mount comprising a belt loop and a first fastener, a holster comprising a pocket, a second fastener adapted to interconnect with the first fastener and to which the holster is attached, and a headband integrated with the holster, the method comprising the steps of: attaching the belt mount to a belt; connecting the first and second fasteners, whereby the holster is suspended from the belt mount; disconnecting the first and second fasteners, thereby separating the holster from the belt mount; and attaching the headband to a user's head.

In use, a user can thus attach the belt mount by passing his or her belt through the belt loop. The flashlight may be stowed in the pocket formed in the front surface of the holster and the second fastener may be engaged with the first fastener thereby interconnecting the flashlight to the belt. If the user needs light while working with his or her hands, the holster can be detached from the belt mount and the headband may be donned by the user with the flashlight facing forward. Once the flashlight is turned on, the user thus has a head mounted light which can be selectively directed at an object to be illuminated.

### BRIEF DESCRIPTION OF THE DRAWINGS

The present invention will be more fully understood and appreciated by reading the following Detailed Description in conjunction with the accompanying drawings, in which:

FIG. 1 is a perspective view of an embodiment of the present invention shown mounted to a user's belt.

FIG. 2 is an exploded perspective view of an embodiment of the present invention.

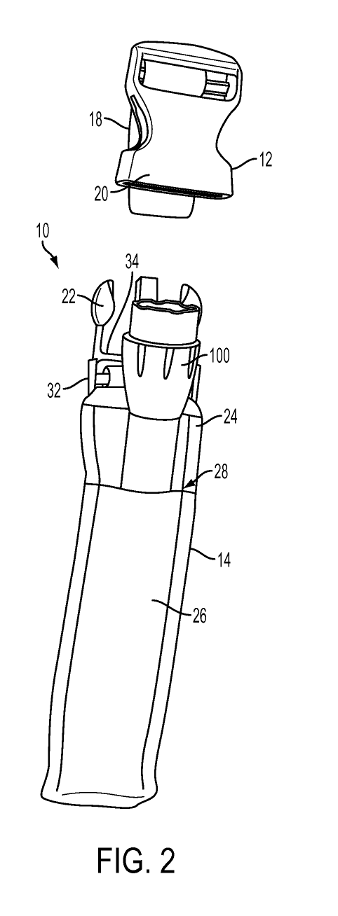

FIG. 3 is a side elevation view of an embodiment of the present invention.

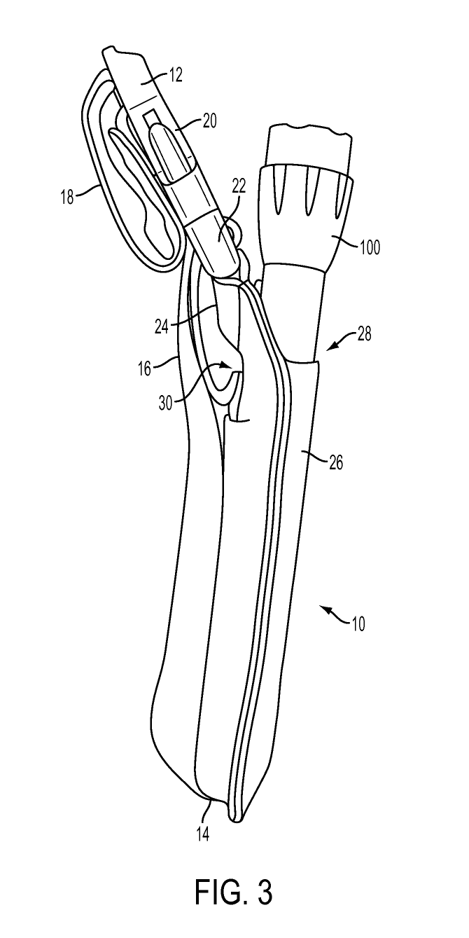

FIG. 4 is a side elevation view of the holster portion of an embodiment of the present invention.

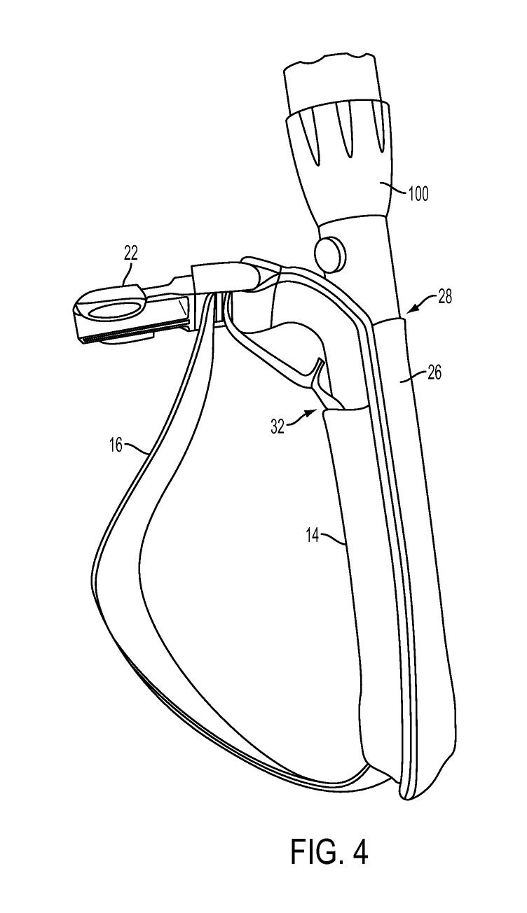

FIG. 5 is a perspective view of an embodiment of the present invention mounted to a user's head.

### DETAILED DESCRIPTION

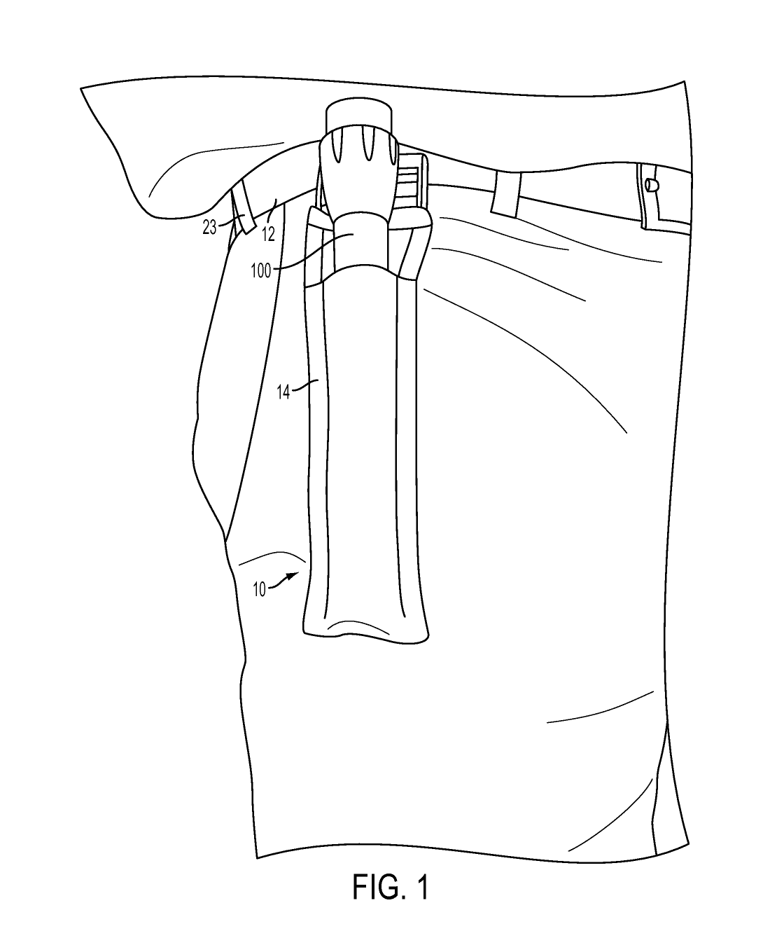

Referring now to the drawings, there is seen in FIG. 1 a flashlight holster assembly, designated generally by reference numeral 10, for containing a flashlight 100. Flashlight holster assembly essentially comprises a belt mount 12, a holster 14 removably mountable to the belt mount 12, and a headband 16 that is integrated with holster 14. Belt mount 12 comprises a belt loop 18 that is attached to a fastening clip 20 (shown as female fastener in Figures but could be other type of fastening pair (VELCRO®, snap, male fastener, grooved fastener, etc.). Holster 14 comprises a complimentary fastening clip 22 (shown as a male fastener is the Figures, but could be any other type of fastener that is complimentary to fastening clip 20). A user of assembly 10 can therefore attach belt mount 12 to his or her belt 23 by passing the belt 23 through belt loop 18, and then holster 14 can be quickly and easily attached or detached from belt mount 12 by connecting or disconnecting fastening clip 22 from fastening clip 20 without having to detach belt mount 12 from the user's belt 23.

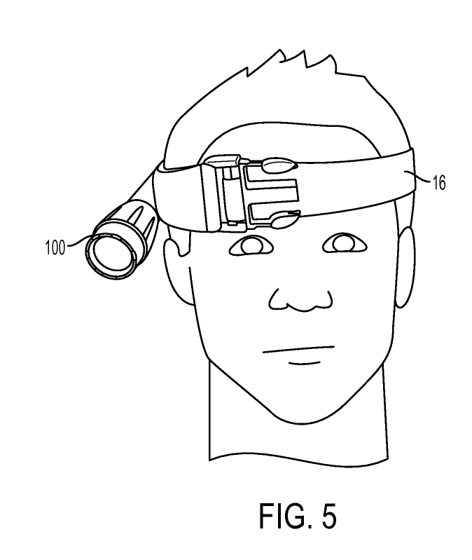

One useful aspect of flashlight holster assembly 10 is its structure that permits conversion between a belt mounted flashlight holster and a headband mounted flashlight holster. Holster 14 comprises a headband 16 integrated therewith that permits the flashlight when contained within the holster to be worn on the user's head as shown in FIG. 5. More specifically, holster 16 comprises an elongated backing of pliable material 24 having an outward facing surface (outward being defined from the perspective of when the holster is worn on a user's belt and faces away from the user) and to which a shorter piece of pliable material 26 is stitched along its bottom and opposing side edges, thereby defining a pocket 28 in which flashlight 100 may be stowed. Holster further comprises a third piece of pliable material, also shorter than the length of backing 24, stitched to the inwardly facing surface of backing 24 but only along its opposing side edges, thereby forming a sleeve 30. Finally, holster 16 comprises fastening clip 22 that is adapted for quick connection to and/or disconnection from fastening clip 20.

Fastening clip 22 includes a bottom strut 32 to which backing 24 is anchored, and an intermediate strut 34 that defines an opening between itself and bottom strut 32. Headband 16 is composed of a strip of elastic material. In assembling holster assembly 10, the strip of elastic material composing headband 16 is passed through sleeve 30 and around strut 34 and through the opening formed between struts 32 and 34 at which time its ends are joined together via stitching (or any other conventional joining process). This provides holster assembly 10 with a headband that is integrated with holster 14 and permits flashlight 100, when stowed in pocket 28, to be worn on the user's head (thereby providing a headlamp) as shown in FIG. 5.

1. A flashlight holster assembly, comprising:
a. a belt mount comprising a belt loop and a first fastener attached to one another;
b. a holster having first and second surfaces and comprising a pocket formed in said first surface and adapted to hold the flashlight therein and a sleeve formed in said second surface;
c. a second fastener attached to said holster and adapted for removable interconnection to said first fastener, thereby providing a means for connecting and disconnecting said holster from said belt mount; and
d. a headband separable from said belt mount and integrated with said holster and positioned through said sleeve, whereby upon disconnection of said holster from said belt mount, said headband may be donned by a user with the flashlight contained within said pocket and extending from said headband.

2. (canceled)

3. (canceled)

4. The flashlight according to claim 1, wherein said headband is attached to said second fastener.

5. (canceled)
